(19) United States
(12) Patent Application Publication
(10) Pub. No.: US 2023/0334470 A1
(43) Pub. Date: Oct. 19, 2023

(54) BLOCKCHAIN INTEROPERABILITY SYSTEM FOR NATIVE ASSET CREATION

(71) Applicant: Spanning Labs Inc., San Francisco, CA (US)

(72) Inventors: Andrew E. Beller, San Francisco, CA (US); Prateek Chandresh Shah, San Francisco, CA (US)

(21) Appl. No.: 17/868,700

(22) Filed: Jul. 19, 2022

Related U.S. Application Data
(60) Provisional application No. 63/330,766, filed on Apr. 13, 2022.

(51) Int. Cl. G06Q 20/36

(52) U.S. Cl. CPC G06Q 20/363; G06Q 2220/00

(57) ABSTRACT

A delegate interoperability network for may include a plurality of delegates instantiated on a plurality of different blockchains. The delegate network may enable blockchain interoperability by receiving, at a first delegate instantiated on a first blockchain, a request to initiate, on a second blockchain, a blockchain action on behalf of a user. The method further includes generating, by the first delegate, a unique delegate network address associated with the user and the first blockchain. The method further includes determining, by the first delegate, whether the second blockchain has sufficient gas token liquidity to complete the blockchain action. The method further includes based at least in part on determining that the second blockchain has sufficient gas token liquidity, sending, to a second delegate instantiated on the second blockchain, a first message to initiate the blockchain action. The method further includes receiving, from the second delegate, a second message, wherein the second message comprises at least an association between the unique delegate network address and the second blockchain.

### CROSS REFERENCE TO RELATED APPLICATIONS

This application claims priority to U.S. Provisional Application No. 63/330,766 filed on Apr. 13, 2022 and entitled “Blockchain Interoperability System for Native Asset Creation,” the entirety of which is incorporated herein by reference.

### BACKGROUND

Through combined ingenuity and effort, Applicants have identified solutions to certain deficiencies and technical problems associated with interoperability between blockchain networks. A blockchain is a record of transactions stored in a digital ledger that is disseminated across devices participating in the blockchain. Blockchains have a variety of uses and may be used to back cryptocurrencies, to attest to the completion of contracts (e.g., smart contracts), to secure accounting and/or auditing efforts, and the like. Each blockchain may have its own protocols for how the ledger is distributed between nodes participating in the blockchain, how the distributed ledger itself is constructed, how blocks/new entries are verified and added to the distributed ledger, what tokens might be native to the blockchain, whether and how smart contracts are executed, and/or the like. However, with the proliferation of blockchains in existence (there are at least tens of thousands of blockchains at the time of writing), means for moving assets or data between blockchains are rudimentary, resulting in major security risks by exposing data and/or currencies to third-parties. Further, conventional means for transacting between blockchains are attended by the need to create wallets, treasuries, or accounts on each blockchain on which a user might like to deal as well as the loss of synchronicity between states in multiple chains. Moreover, existing techniques for moving assets from an original blockchain to a target blockchain rely on a bridge that wraps tokens—such wrapped tokens possibly losing their collateralization, such as if a transaction is reverted on the original blockchain. Even further, such wrapped tokens may not have the full functionality of a token that is native to the target blockchain.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a block diagram of an example environment within which a delegate interoperability network may operate.

FIG. 2 illustrates a block diagram of an example blockchain system node.

FIG. 3 illustrates a flow chart depicting an example method for requesting a transaction on an originating blockchain in the delegate interoperability network.

FIG. 4 illustrates a flow chart depicting an example method for creating a transaction on a target blockchain in the delegate interoperability network.

### DETAILED DESCRIPTION

As discussed above, blockchains have proliferated along with the protocols for transacting on blockchains. A blockchain protocol may specify how blocks are added to the chain, which may include specifying a ruleset governing how transactions occur and are validated for addition to the chain, the algorithm, software, different block types and their respective functionality, and/or hardware for interaction between nodes of the blockchain (i.e., computing devices participating in the blockchain, and, in some cases, an application programming interface (API) that provides access to blockchain node(s) and/or a client network). In an example, a user who wants to move an asset from one blockchain (an originating blockchain) to another blockchain (a target blockchain) or that wants to use a blockchain asset on a first blockchain to pay for goods or services on another blockchain may be exposed to security risks that may result in the loss of cryptocurrency, loss of data, and/or invalidation of smart contracts held in either blockchain. In some examples, a blockchain asset may comprise a token, such as a unit(s) of cryptocurrency, data such as a message, or the like. Moreover, blockchain assets on the originating blockchain may not have the same, full functionality that a native asset on the target blockchain has.

For example, a user might have a wallet that includes one or more private keys that prove that the user is entitled to cryptocurrency (e.g., Bitcoin, the originating blockchain asset) or other assets on a first blockchain (e.g., the Bitcoin blockchain, the originating blockchain). But, the user may want to purchase a good or service that is offered for sale via payment in a second type of cryptocurrency (e.g., Ethereum). The blockchain that is being acted upon is referred to herein as the target blockchain and cryptocurrency associated with such a blockchain may be referred to as the target asset, e.g., Ethereum, the second type of cryptocurrency, in the example above. Currently, a user would have to set up a second account/wallet with the Ethereum blockchain and purchase new Ethereum cryptocurrency. Alternatively, if the user wants to use their Bitcoin cryptocurrency to purchase the good or service, could use a service called a bridge, which may be provided by the target blockchain or a third-party. The user would transmit a Bitcoin to the bridge, which would lock-up the value associated with that Bitcoin, and the bridge would mint a new Ethereum asset (e.g., a token) on the Ethereum chain that essentially states that the newly minted Ethereum asset is backed by a Bitcoin of commensurate value (plus a transaction fee to the bridge creator). The bridge is supposed to track whether the value is still locked up at the bridge and the newly minted Ethereum asset can be used like other Ethereum assets.

However, the bridge is responsible for custody of the value backing the newly minted Ethereum asset. This introduces multiple attack surfaces because the state of the value of the respective assets are now managed across three different points: the original blockchain (the Bitcoin chain), the bridge, and the target blockchain (the Ethereum chain). If the original transaction on the Bitcoin chain is reverted, the newly minted Ethereum asset is no longer collateralized. This may introduce an attack vector for bad actors, and undermines the trust necessary for blockchains to operate as a decentralized source of truth for transactions. This may further result in the devaluation of either chain's assets, the theft of cryptocurrency, and/or fraudulent transactions. To further complicate matters, Bitcoin's protocol would need to be compatible with creating smart contracts that specify that blockchain assets are fungible on Ethereum. In other words, not every originating blockchain's assets may be supported on a target blockchain.

Moreover, for a blockchain to add compatibility for other blockchain assets, such as an Ethereum developer that wants a new cryptocurrency to be available on the Ethereum blockchain, the developer may need to develop a new type of token on Ethereum to be compatible with assets of the other blockchain. With the proliferation of blockchains, this means that a developer for a particular blockchain may need to continually develop new tokens or bridge protocols to handle new token types and, even then, bridge protocols expose users to security hazards and token use limitations that wouldn't otherwise be encountered for native tokens. Further illustrating the deficiencies of conventional methods, the process of wrapping an asset via a bridge may take from minutes (e.g., 5-7 minutes) to weeks to complete, depending on the trust mechanisms built into the bridge.

The techniques discussed herein transfer assets in seconds (e.g., 3 seconds, 4 seconds, 5 seconds, 8 seconds) and improve the security and functionality of assets transferred between blockchains by introducing a novel network of delegates comprising contract-to-contract interfaces instantiated on and between host blockchains. A delegate may be deployed as a smart contract on a blockchain and may include a unique protocol that includes a ruleset and operable functionality. In some cases, the unique protocol may enable the delegate to directly reference a user or asset owner on another (e.g., a target) blockchain. In this way, the delegate may be configured to facilitate inter-blockchain transactions or other communications. Thus, for example, the delegate's functionality may include transferring assets from one user to another. In some cases, such an asset transfer may comprise updating an ownership field (or any other relevant variable or data).

The delegate's functionality may further include reporting events on the host blockchain and/or other blockchains to a user, sending messages signed by the user and the delegate to another target blockchain, ensuring that the target blockchain has sufficient gas (e.g., the fee minted on the target blockchain to pay a mining computing device that achieves a proof-of-work or proof-of-stake) token liquidity to process the message before sending the message, receiving signed messages from delegates on other blockchains, and acting on the behalf of a user on the host blockchain (e.g., such as when the user does not possess proof of ownership for assets on the host blockchain). In some examples, the delegate may construct a globally unique address (referred to herein as a spanning address) that uniquely identifies the user globally across all blockchains and makes the user addressable across different blockchains. This may close a security loophole for spoofing users given that, currently, two different blockchains may identify two different users with a same address. The ruleset associated with a delegate may define the domain identifier of the current network, define whether the host chain is deployable or read-only, and/or define the current deployment version of the delegate.

A network of these delegates may be managed by a decentralized autonomous organization (DAO), which may itself comprise a set of smart contracts that control operations of the delegates and/or blockchain, which may be backed by a cryptocurrency. Functionally, this network of delegates would allow a user to use a private key for an asset generated on an originating blockchain as proof of ownership for an asset on a different, target blockchain. In some examples, a developer may allow assets from other blockchains to be converted into assets on the developer's blockchain (instead of representing or wrapping those assets) simply by deploying a delegate with such authority on the developer's blockchain. This vastly simplifies the process for making other blockchains' assets available on the developer's blockchain. Moreover, the network of delegates allows a user to reduce gas costs for transacting between blockchains. For example, the network of delegates may be configured, in at least some instances, to transmit metatransactions on behalf of a user. A metatransaction may be a transaction which contains another transaction (i.e., the actual transaction). The actual transaction may be signed by a user and then transmitted to a delegate (e.g., delegate 102 or delegate 106). Thus, a delegate may “pay itself” the gas cost of the transaction, thereby eliminating the need for a user to own a wallet or any amount of gas token associated with an underlying blockchain.

### EXAMPLE ENVIRONMENT

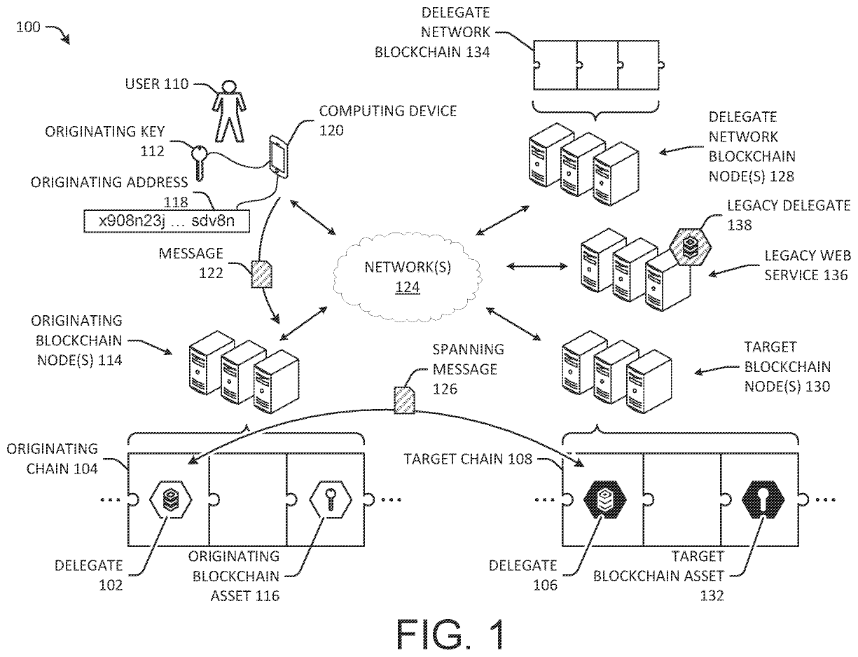

FIG. 1 illustrates a block diagram of an example environment 100 within which techniques discussed herein may be implemented. In some examples, the environment 100 includes a delegate network comprising different delegates instantiated on different blockchains. For example, FIG. 1 includes a first delegate 102 deployed on a first blockchain (the originating chain 104 in the depicted example) and a second delegate 106 deployed on a second blockchain (the target chain 108 in the depicted example). The originating chain 104 and the target chain 108 are respective digital ledgers that are disseminated to all the node(s) (computing device(s)) participating in the respective blockchains. These distributed ledgers are, essentially, an encrypted record of the transactions that have been verified via a consensus of the blockchain node(s) according to the protocol set out by the respective blockchain. Each blockchain node receives a copy of this ledger and participates in a consensus that the distributed ledger is accurate (such as by verifying the hash associated with the most recently distributed copy of the ledger). Every time a block/transaction is added to the blockchain, a new copy of the ledger is disseminated to the nodes.

In some examples, the delegate 102 and the delegate 106 may each comprise a smart contract deployed on their respective blockchains. These smart contracts may differ from each other, depending on the availability of smart contract functionality on the respective blockchain and the smart chain protocol. In additional or alternate examples, a delegate may be an API, a hook into code and/or a relayer network, a public web socket or Remote Procedure Call ((RPC) particularly, any protocol that can submit signed attestations), a dedicated server/endpoint, an Internet Protocol (IP) delegate, Short Message Service (SMS) delegate, satellite delegate, a microwave delegate or the like. Thus, the delegate 102 and the delegate 106 may respectively define a ruleset(s) and operable functionality. In examples, such operable functionality includes but is not limited to reporting multichain events to the user 110, sending messages signed by the user 110 and the delegate (e.g., the delegate 102 or the delegate 106), and receiving signed messages from delegates on other blockchains. Moreover, the delegate 102 and the delegate 106 may each be implemented in any programming language(s) capable of instantiating conditional statements and conditional branching.

The first blockchain may be an “originating” blockchain according to a first use case where our example user (i.e., the user 110 in the depicted example) possesses proof of ownership of an asset associated with the first blockchain, and wants to transact over a second blockchain—the “target chain.” The originating chain 104 and the target chain 108 may be different blockchains, by virtue of being different forks of a same parent blockchain (e.g., Bitcoin Classic versus Bitcoin Cash or Bitcoin Gold) and/or by virtue of being completely different blockchains (e.g., Bitcoin Classic versus Ethereum or ETH 2.0). In some examples, the target chain 108 may be a programmable blockchain, such as Ethereum, Binance Smart Chain (BSC), Avalanche, Polygon, Solana, and/or Fantom. In such an instance, a delegate deployed thereon may have full permissions (e.g., allowing inbound and/or outbound messaging, capable of writing to local contracts). Additionally, or alternatively, the target chain 108 may be a read-only blockchain, in which case a delegate deployed thereon may have reduced permissions, such as supporting only outbound messaging, which may allow such a delegate to interact with target chains, but local contracts may be unavailable to be written to from a remote chain.

In some examples, the user's proof of ownership of an asset on the originating chain 104 may be a private key (e.g., originating key 112) generated as part of an asymmetrical encryption algorithm executed by one or more of the originating blockchain node(s) 114 participating in verifying a transaction on the originating chain 104, according to the originating chain 104 protocol. In some examples, the originating key 112 and/or originating address 118 may be stored in a computing device 120 associated with the user. Although the computing device 120 is depicted as a smartphone, the computing device 120 may be any other computing device, such as a distributed computing service, field-programmable gate array, application-specific integrated circuit, mining cluster, desktop device, laptop, or the like. In other examples, the originating key 112 and/or originating address 118 may be stored in memory that is removably coupled to the computing device 120, such as various cold storage options, which may include network-disconnected or isolated computing device(s), memory device(s) (e.g., hard drive, flash drive), and/or the like. In yet other examples, the originating key 112 and/or the originating address 118 may be stored on a paper wallet (e.g., a printed pairing of the originating key 112/originating address 118 and one or more QR codes).

In additional or alternate examples, the proof of ownership may include a one-time password derived from a private key. The aforementioned transaction may transfer an originating blockchain asset 116 to an originating address 118 associated with the user. In examples, the originating blockchain asset 116 may include a token, such as a cryptocurrency of a first type (e.g., Bitcoin token(s), Bitcoin Cash, Bitcoin Gold, Bitcoin XT, BIP 102, BIP 103, ETH 2.0, Litecoin(s), dogecoins), data, or the like. Thus, the originating key 112 may be used by our example user to prove ownership of the originating blockchain asset 116 for transactions on the originating chain 104, via the transaction governance and verification protocols that coordinate the originating blockchain node(s) 114.

According to methods disclosed herein, when the user wants to purchase a good or service or otherwise transact via another blockchain, such as the target chain 108, he may use an application programming interface (API) or may otherwise transmit a message 122 via network(s) 124 to the delegate 102 on the originating chain 104 to request a transaction on the target chain 108. Network(s) 124 may include wired and/or wireless as well as public and/or private networks. Network(s) 124 may include one or more cross-chain communication layers to facilitate the transmission of messages or data over the delegate network—such as transmitting messages to/receiving messages from delegates instantiated on different blockchains and/or Web 2.0 services. In some examples, the cross-chain communication layer may comprise a blockchain operating system. The blockchain operating system may comprise a publish-subscribe architecture using a machine-to-machine/middleware communication standard (e.g., data distribution service (DDS), remote procedure calls (RPCs) via Websockets requests, message queueing telemetry transport (MQTT)). Thus, the blockchain operating system may listen for messages (“events”) from other blockchain(s), and, if a message meets certain criteria (e.g., if the message is from a delegate), it may forward the message to a delegate associated with the target chain 108 (as specified by the spanning address). In some other examples, the cross-chain communication layer may comprise an intermediate blockchain. In such examples, a standard protocol for transmitting data packets between independent blockchains (such as the inter-blockchain communication protocol) may defer trust onto the consensus of an intermediate blockchain. In other words, the delegate network may not forward a message to a destination blockchain if the message has not been authenticated by a consensus of the intermediate blockchain. In some examples, the intermediate blockchain may be associated with the delegate network.

In examples wherein an API facilitates transmission of the message 122, each of the nodes 114 may be configured to authenticate or otherwise verify that the user is entitled to communicate over the network 124. Moreover, each of the nodes 114 may be configured with its own methods for interacting with applications over the network 124 (such as, for example, utilizing different programming languages when implementing an API such as JSON-RPC).

The message 122 may include the originating address 118 and identify the originating blockchain asset 116 as well as prove the user's ownership thereof by signing the originating blockchain asset 116 using the originating key 112 (which doesn't expose the originating key 112 to the delegate 102). Techniques for signing the originating blockchain asset 116 may include, for example, elliptic key cryptography or the like. In some examples, the message 122 may be a new transaction/request for a new transaction to be entered on the originating chain 104 that makes a call to the delegate 102 as an input to the new transaction on the originating chain 104. The message 122 or new transaction may identify the target chain 108 as the chain that the user would like to interact with or transact on. The message 122 may additionally or alternatively identify a type of transaction that the user wants to conduct, a value associated therewith, and/or any functions that user wants to call on the target chain 108 (which may be unique to the target chain 108 and/or not available on the originating chain 104, in some examples).

In an additional or alternate example, the message 122 may originate from a legacy web service 136, such as a Web 1.0 or Web 2.0 service (e.g., a social media site, digital media service, e-commerce site, or the like). In other words, the legacy web service 136 is not a Web3, i.e., blockchain/decentralized-based solution. In such an instance, a legacy delegate 138 may be deployed on the legacy web service 136. In some examples, the legacy delegate 138 may not be a smart contract, because the legacy web service 136 may not be capable of deploying a blockchain smart contract. However, the legacy delegate 138 may be a smart contract if the legacy web service 136 incorporates a blockchain that supports smart contracts. Additionally, or alternatively, the legacy delegate 138 may include an API and web service for receiving a Web 1.0 or 2.0 signature, certificate, or the like from the user (such as authenticates Web 1.0 and 2.0 transactions) to authenticate the user and to authenticate transmission or receipt of an asset available via Web 1.0 or 2.0, such as via a legacy payment processor, bank, credit card company, or the like.

Based at least in part on determining that the target chain 108 has sufficient gas token liquidity, the delegate 102 may transmit to the delegate 106 a message 126 (the spanning message 126 shown in the depicted example) initiating the transaction on the target chain 108. In some cases, an internal relay network comprising the target chain 108 may be configured to determine gas token liquidity. In one example, each node of the target blockchain nodes 130 may communicate a status message (e.g., a heartbeat message) indicating its constituent gas token liquidity upstream and also receive a similar downstream message. In another example, one or more of the target blockchain nodes 130 may be configured to estimate the target chain 108's gas token liquidity based on previous transactions. The gas token liquidity data may then be communicated over the network 124 to the originating chain 104 (i.e., any of the originating blockchain nodes 114). In some other cases, the target chain's gas token liquidity may be determined using an external oracle network. The external oracle network may be a decentralized set of validators that must come to consensus on the target chain 108's gas token liquidity before providing that data back to the originating chain 104. The message 126 may comprise the spanning address associated with our example user. To facilitate the transaction, the delegate 106 may store an association of the user's spanning address with the target chain 108 and/or the target blockchain asset 132.

Based at least in part on receiving the message 126, the delegate 106 may cause the transaction to occur on the target chain 108, which may include initiating a new transaction on the target chain 108 and/or creating a blockchain asset associated with the target chain 108. For example, any of the target blockchain node(s) 130 may receive the new transaction request and, depending on the type of transaction requested, create the target blockchain asset 132, create and spend the target blockchain asset 132 (by identifying a payee address on the target chain 108), or the like. The delegate 106 may store verification that the transaction is completed. Additionally, or alternatively, the delegate 106 may transmit a spanning message to the delegate 102 that identifies the spanning address associated with the user and an asset balance for the user associated with the target chain 108.

As part of verifying the transaction, one or more of the originating blockchain node(s) 114 may be mining computing devices that may generate a proof of work, proof of stake, or other consensus (blockchain protocols may specify different consensus means) by finding a solution to a problem or completing a task of some kind first (e.g., typically a complex mathematical function or, in the case of proof of stake, consensus may be reached using validation by those having a largest stake in a cryptocurrency). Once a proof of work or proof of stake has been found, other node(s) of the originating blockchain node(s) 114 may add the transaction to the originating chain 104 by verifying that a hash of the new transaction concatenated to the former ledger matches a hash posted by the node that posted the proof of work or proof of stake. In some examples, the blockchain includes blocks that each record one or more transactions conducted via the blockchain. The number of transactions recorded by a block, L, may depend on a block size specified by the blockchain protocol, which may vary based on the cryptocurrency type (e.g., Bitcoin, Ethereum) and/or the cryptocurrency fork (e.g., Bitcoin Classic, Bitcoin XT, BIP 102, BIP 103). Therefore, the number of transactions recorded in a block may vary based on the size.

Some of the computing device(s) making up a blockchain's node(s) may be “miners” that create new blocks from un-blocked transactions. A mining computing device receives requests for new transactions and verifies the un-blocked transactions by determining that each un-blocked transaction accords with the cryptocurrency scheme (e.g., the un-blocked transaction includes valid signature(s), a sum of output(s) of the un-blocked transaction is no greater than the sum of input(s)). Once the mining computing device verifies enough un-blocked transactions to meet a block size specified by the blockchain protocol, the mining computing device has identified a potential block that could be added to the blockchain. For this block to be added to the blockchain, according to the blockchain protocol, the miner must first generate a hash of the block concatenated to the blockchain that accords with a criterion specified by the blockchain protocol. The hash generated is an encryption of the entire blockchain plus the potential block.

In an example where the blockchain protocol requires a proof of work to verify a new block, the mining computing device may apply a hash function (e.g., SHA-256) to the potential block concatenated to the former blocks to generate a hash until the hash starts with a minimum number of zeros (i.e., the hash is a small number, e.g., a hash that starts with 72 zeros))—this is an example of a problem that the blockchain node(s) may race to solve in order to earn “gas,” a fee for the computational services rendered by the mining computing device. These hashes are generated randomly, so the miner repeatedly reattempts to generate a hash that meets the hash criterion until the miner generates a hash that meets the hash criterion or until another miner generates a hash that meets the hash criterion, in which case the miner will start the process over.

When a mining computing device finds a hash that accords with the hash criterion, the miner transmits an announcement to other mining computing devices participating in that blockchain that the miner found a hash for the potential block. The other mining computing devices that receive the announcement check to make sure that the hash value accords with the hash criterion and that transactions of the potential block are valid (e.g., the un-blocked transaction includes valid signature(s), a sum of output(s) of the un-blocked transaction is no greater than the sum of input(s)). So long as these conditions are met, the other mining computing devices add the potential block to the blockchain as the next block of the blockchain and continue adding blocks per this scheme. The hash thereby reflects the entire chain of blocks that have been accepted by the multiple computers of the blockchain ledger system.

The environment 100 may also include a delegate network blockchain 134, comprising delegate blockchain nodes 128. That is, the example infrastructure depicted by environment 100 and facilitating the functionality described herein may comprise the delegate network blockchain 134. The delegate network blockchain 134 depicted in FIG. 1 may support both Ethereum Virtual Machine (EVM)-compatible networks and non-EVM blockchains, as well as non Web3 networks.

### EXAMPLE SYSTEM(S)

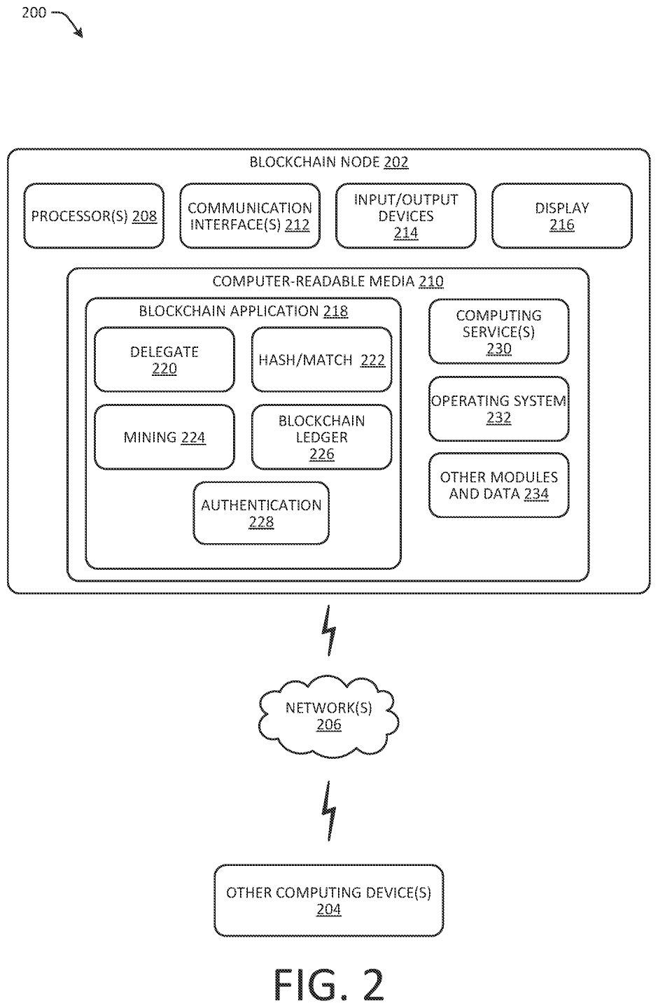

FIG. 2 illustrates an example architecture 200 of the blockchain system discussed herein, including an example blockchain node 202. In some examples, the blockchain node 202 may represent the computing device 120 or either of the originating blockchain node(s) 114 or the target blockchain node(s) 130. The example blockchain node 202 may thus represent any node of the blockchain system, regardless of what functions the node fulfills (e.g., whether the node merely accesses the blockchain ledger to conduct authentication without contributing verifications/denials to the blockchain, the node contributes verifications/denials to the blockchain (e.g., the node is registered), or the node additionally or alternatively conducts mining).

The example architecture 200 may include example blockchain node 202, which may communicate with other computing device(s) 204 (e.g., other node(s) of the same blockchain or, in an example where the blockchain node 202 includes a delegate, node(s) of a different blockchain) via network(s) 206 (e.g., the Internet, cable network(s), cellular network(s), wireless network(s) (e.g., Wi-Fi) and wired network(s), as well as close-range communications such as Bluetooth®, Bluetooth® low energy, and the like). Network(s) 206 may represent network(s) 124 discussed above with reference to FIG. 1. In some examples, the other computing device(s) 204 may include other nodes of the blockchain system and/or a user computing device such as, for example, computing device 120.

The node 202 may be configured as any appropriate node type, including being configured as a light node, a full node, or an archive node. In some examples, the example blockchain node 202 may be any suitable type of computing device, e.g., portable, semi-portable, semi-stationary, stationary, distributed (cloud) computing device(s). Some examples of the example blockchain node 202 may therefore include tablet computing devices, smart phones and mobile communication devices, laptops, netbooks and other portable computers or semi-portable computers, desktop computing devices, terminal computing devices and other semi-stationary or stationary computing devices, dedicated register devices, wearable computing devices, or other body-mounted computing devices, augmented reality devices, distributed (cloud) computing device(s), or other computing devices capable of sending communications and performing the functions according to the techniques described herein. In some examples, the example blockchain node 202 may include one or more servers or other types of computing devices that can be embodied in any number of ways. In the example of a server, hardware, functional components, and data discussed herein can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the example blockchain node 202 as being present in a single location, these components and data may alternatively be distributed across different computing devices and different locations in any manner suitable to perform the functions described herein. Consequently, the functions may be implemented by one or more serving computing systems, with the various functionality described above distributed in various ways across the different computing devices. Multiple server computing device(s) may be located together or separately, and be organized, for example, as virtual servers, server banks and/or server farms. The described functionality may be provided by the servers of a single entity or enterprise, or may be provided by the servers and/or services of multiple different customers or enterprises.

In the illustrated example, the example blockchain node 202 includes one or more processors 208, one or more computer-readable media 210, one or more communication interfaces 212, one or more input/output (I/O) devices 214, and/or a display 216.

Each processor 208 may itself comprise one or more processors or processing cores. For example, the processor(s) 208 may be implemented as one or more microprocessors, microcomputers, microcontrollers, digital signal processors, central processing units, state machines, logic circuitries, and/or any devices that manipulate signals based on operational instructions. In some examples, the processor(s) 208 may be one or more hardware processors and/or logic circuits of any suitable type specifically programmed or configured to execute the algorithms and processes described herein, such as a central processing unit (CPU), graphics processing unit (GPU), data processing unit (DPU), application-specific integrated circuit (ASIC), field-programmable gate array (FPGA), and/or the like. The processor(s) 208 may be configured to fetch and execute computer-readable processor-executable instructions stored in the computer-readable media 210 to conduct any of the operations discussed herein.

Depending on the configuration of the example blockchain node 202, the computer-readable media 210 may be an example of tangible non-transitory computer storage media and can include volatile and nonvolatile memory and/or removable and non-removable media implemented in any type of technology for storage of information such as computer-readable processor-executable instructions, data structures, program modules or other data. The computer-readable media 210 may include, but is not limited to, RAM, ROM, EEPROM, flash memory, solid-state storage, magnetic disk storage, optical storage, and/or other computer-readable media technology. In some examples, the computer-readable media 210 or a portion thereof may be operably disconnected from the blockchain node 202, such as for cold storage solutions. Further, in some examples, the example blockchain node 202 may access external storage, such as RAID storage systems, storage arrays, network attached storage, storage area networks, cloud storage, or any other medium that can be used to store information and that can be accessed by the processor(s) 208 directly or through another computing device or network. Accordingly, the computer-readable media 210 may be computer storage media able to store instructions, modules or components that can be executed by the processor(s) 208. Further, when mentioned, non-transitory computer-readable media expressly exclude media such as energy, carrier signals, electromagnetic waves, and signals per se.

The computer-readable media 210 may be used to store and maintain any number of functional components that are executable by the processor(s) 208. In some implementations, these functional components comprise instructions or programs that are executable by the processor(s) 208 and that, when executed, implement operational logic for performing the actions and services attributed above to the example blockchain node 202. Functional components stored in the computer-readable media 210 that may be executed by the processor(s) 208 to perform such actions and services may include a blockchain application 218, which itself may include a delegate 220 (e.g., if a delegate has been deployed on the blockchain associated with the blockchain node 202—note that the delegate 220 may alternatively be part of the blockchain ledger 226), which may represent any of the delegates discussed herein, a hash and/or match module 222, a mining component 224 (e.g., if the example blockchain node 202 is being used to mine new blocks), a copy of the blockchain ledger 226, which may represent originating chain 104, target chain 108, and/or delegate network blockchain 134, and an authentication module 228.

In some examples, the functional components stored in the computer-readable media 210 may additionally or alternatively include computing service(s) 230, which may represent services run by computing device 120 in one example or legacy web service 136 in another example, an operating system 232, and/or other modules and data 234, which may include programs, drivers, etc., and the data used or generated by the functional components. In some examples, the computing service(s) 230 may include a DAO ruleset, any of the API(s) discussed herein or hosted services to which the API(s) make calls, etc. The operating system 232 may control and manage various functions of the example blockchain node 202 for enabling basic user interactions. In addition, the computer-readable media 210 may also store data, data structures and the like, that are used by the functional components.

In some examples, the hash/match component 222 may be configured to receive personal information, hash the personal information according to a blockchain key (e.g., using a cryptographic key of the blockchain, formatting the personal information according to a formulation specified by the blockchain key before hashing), and attempt to match the hashed personal information to verification(s)/denial(s) in the blockchain ledger 226. In some examples, the criteria for determining whether a verification/denial is a match may be specified by the blockchain protocol.

The blockchain application 218 may also determine instructions for generating a user interface at a user's computing device and/or transmitting and receiving the various requests discussed herein (e.g., message 122 and/or other requests for transacting on a blockchain that the user 110 does not have assets on). In some examples, the blockchain application 218 may generate and/or send the instructions to any of the delegates of the delegate network and/or to the delegate network blockchain 134. In some examples, the blockchain application 218 may send an electronic communication (e.g., an email, a text message, a push notification, a blockchain transaction, an instruction, message) to the computing device 120 and/or may receive messages therefrom. This may be reversed where the blockchain node 202 is the computing device 120, in which case the blockchain application 218 may transmit and/or receive such instructions and/or cause the various UI elements to be displayed, as discussed herein. In an additional or alternate example, the blockchain application 218 may include a software client disseminated in associated with a particular blockchain to participate in that blockchain.

The communication interface(s) 212 may include one or more interfaces and hardware components for enabling communication with various other devices, such as over the network(s) 206 or directly. For example, communication interface(s) 212 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

The example blockchain node 202 may further include the one or more I/O devices 214. The I/O devices 214 may include speakers, a microphone, a camera, an accelerometer, gyroscope, compass, proximity sensor, and/or a switch, various user controls (e.g., buttons, a keyboard, a keypad, a touch screen), a haptic output device, and so forth. Additionally, the example blockchain node 202 may include various other components that are not shown, examples of which include removable storage, a power source, such as a battery and power control unit, and so forth.

In at least one example, example blockchain node 202 may include a display 216. Depending on the type of computing device(s) used as the example blockchain node 202, the display 216 may employ any suitable display technology. For example, the display 216 may be a liquid crystal display, a plasma display, a light emitting diode display, an OLED (organic light-emitting diode) display, an electronic paper display, or any other suitable type of display able to present digital content thereon. In some examples, the display 216 may have a touch sensor associated with the display 216 to provide a touchscreen display configured to receive touch inputs for enabling interaction with a graphic interface presented on the display 216. Accordingly, implementations herein are not limited to any particular display technology. Alternatively, in some examples, example blockchain node 202 may not include the display 216, and information can be presented by other means, such as aurally or purely via a network to another device that does or does not include a display.

### EXAMPLE METHOD(S)

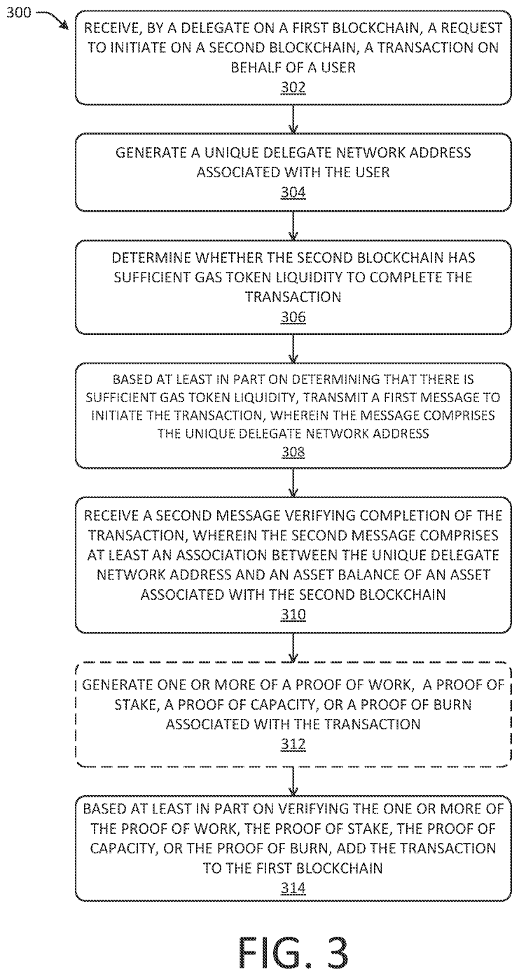

FIG. 3 illustrates a flow chart depicting an example method 300 for requesting a transaction on an originating blockchain in the delegate interoperability network. At step 302, our example user may transmit a message 122 via network(s) 124 to the delegate 102 on the originating chain 104 to request a transaction on the target chain 108. In some examples, the user may use an application programming interface (API) to transmit the message 122. Such APIs may include, for example, standard Web3 EVM JSON-RPC APIs. The message 122 may include the user's originating address 118 and may identify the originating blockchain asset 116 as well as prove the user's ownership by signing the originating blockchain asset 116 using the originating key 112 (which doesn't expose the originating key 112 to the delegate 102). In some examples, the message 122 may be a new transaction/request for a new transaction to be entered on the originating chain 104 that makes a call to the delegate as an input to the new transaction on the originating chain 104. The message 122 or new transaction may identify the target chain 108 as the chain that the user would like to interact with or transact on. The message 122 may additionally or alternatively identify a type of transaction that the user wants to conduct, a value associated therewith, and/or any functions that the user wants to call on the target chain 108 (which may be unique to the target chain 108 and/or not available on the originating chain 104, in some examples).

In an example where the user transmits the message 122 via a legacy web service 136, (e.g., a Web 1.0 or Web 2.0 service such as a social media site, digital media service, e-commerce site, or the like), any of the blockchain node(s) 114 may be configured to authenticate the user by signed attestation (e.g., public-private key encryption pair) rather than or in addition to verifying by consensus. In an example where the user makes their request over a Web 2.0 website, let's say, this attestation may be accomplished by the WebAuthn API or the like. In this way, the delegate interoperability network described herein further promotes a cheaper and more efficient blockchain ecosystem.

At step 304, the delegate 102 may generate a spanning address associated with the user. In examples, a spanning address may include a bytes32 that contains both the local address and a domain identifier, although additional or alternate addresses are considered and may be longer. The domain identifier is unique to each deployed delegate (e.g., delegate 102 or delegate 106) and thus is unique to each network. A single network may also support multiple delegates and domains for application-specific delegates or future updated network versions.

At step 306, the delegate 102 may determine whether the target chain 108 has sufficient gas token liquidity to complete the user's requested transaction. In some examples, this determination may further include determining whether the target chain 108 is a deployable blockchain or a read-only blockchain. Determining whether the target chain 108 is a deployable blockchain or a read-only blockchain, in some cases, may occur via regular status updates (e.g., via heartbeat messages or the like) of an internal relayer network or an external oracle network. Such status updates may be simultaneously transmitted to each delegate of a given network.

At step 308, based at least in part on determining that the target chain 108 has sufficient gas token liquidity, the delegate 102 may transmit a message 126 (i.e., a spanning message 126) to the delegate 106 associated with the target chain 108 and/or node(s) 128 participating in a delegate network blockchain 134. In some examples, the message 126 may be a new transaction on the delegate network blockchain 134 and may be readable by the delegate 106, such as when the target chain 108 implements a virtual machine that is supported by the delegate interoperability network. Although, in additional or alternate examples, the message 126 may be a newly requested transaction on the target chain 108 that calls functionality of the delegate 106. In some examples, the message 126 may identify the transaction that the user wants to cause, such as a value of assets that the user wants to transact in on the target chain 108, functions the user wants to call on the target chain 108, etc.

At step 310, the delegate 102 may receive, from the delegate 106, a second spanning message (indicated by the double arrow emanating from the depicted message 126). The second spanning message may be a verification that the user's requested transaction is complete, in that it shows an association between the user's spanning address and an asset balance of an asset associated with the target chain 108 as a result of the user's requested transaction.

At optional step 312, the delegate 102 (i.e., one or more nodes of the originating blockchain nodes 114) may generate one or more consensus proofs associated with the user's transaction. These consensus mechanisms may include, for example, one or more of a proof of work, a proof of stake, a proof of capacity, a proof of burn, or a proof of elapsed time associated with the user's requested transaction.

At step 314, based at least in part on verifying the one or more of a proof of work, a proof of stake, a proof of capacity, a proof of burn, or a proof of elapsed time, the delegate 102 (i.e., one or more other nodes of the originating blockchain nodes 114) may add the user's transaction to the originating chain 104.

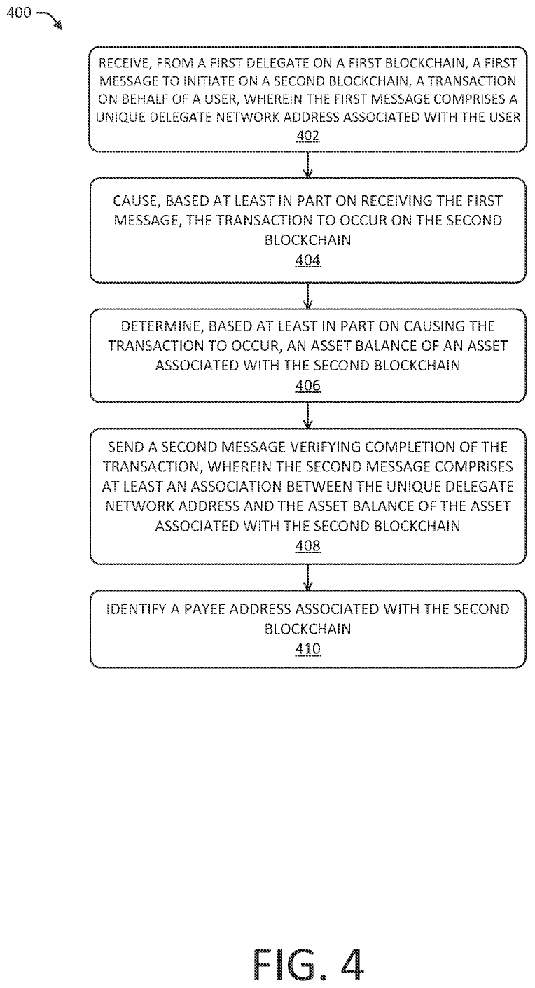

FIG. 4 illustrates a flow chart depicting an example method 400 for creating a transaction on a target blockchain in the delegate interoperability network. At step 402, the delegate 106 may receive the message 126 sent by the delegate 102 as described above with reference to step 308.

At step 404, based at least in part on receiving the message 126, the delegate 106 may cause the user's requested transaction to occur on the target chain 108, which may include creating a new transaction on the target chain 108. In some examples, the delegate 106 may store an association of the user's spanning address with the target blockchain asset 132. For example, the delegate 106 may be configured to act as or otherwise interact with a crypto wallet on the user's behalf. Further, the target blockchain node(s) 130 may receive the new transaction request and, depending on the type of transaction requested, the target blockchain node(s) 130 may create the target blockchain asset 132, create and spend the target blockchain asset 132 (by identifying a payee address on the target chain 108), or the like.

At step 406, the delegate 106 may determine, based at least in part on causing the user's requested transaction to occur on the target chain 108, an asset balance for an asset associated with the target chain 108 (such as the target blockchain asset 132 depicted in FIG. 1). Example, protocols for determining the asset balance for the asset associated with the target chain 108 include but are not limited to UTXO (such as is employed in the Bitcoin blockchain) and accounting (such as is employed in the Ethereum blockchain) protocols.

At step 408, the delegate 106 may transmit a second spanning message to the delegate 102 associated with the originating chain 104 that verifies completion of the transaction. In some examples, the spanning message may associate the spanning address associated with the user and the asset balance calculated above with reference to step 406. In some examples, the delegate 106 may also store verification that the transaction completed such as according to the target chain 108's protocols.

At step 410, the delegate 106 may identify a payee address associated with the target chain 108. In some examples, the delegate 106 may retrieve the payee address from a memory associated with the target blockchain node(s) 130. For example, the payee address may be an address associated with frequent transactions from the user's spanning address.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

### EXAMPLE CLAUSES

A. A system comprising: one or more processors; and computer readable media storing instructions that, when executed by the one or more processors, cause the system to perform operations comprising: receiving, by a first delegate instantiated on a first blockchain, a request to initiate, on a second blockchain, a transaction on behalf of a user; generating, by the first delegate, a unique delegate network address associated with the user; determining, by the first delegate, whether the second blockchain has sufficient gas token liquidity to complete the transaction; based at least in part on determining that the second blockchain has sufficient gas token liquidity, sending, to a second delegate instantiated on the second blockchain, a first message to initiate the transaction, wherein the first message comprises the unique delegate network address; receiving, from the second delegate, a second message verifying completion of the transaction, wherein the second message comprises at least an association between the unique delegate network address and an asset balance of an asset associated with the second blockchain; and based at least in part on verifying the one or more of the proof of work, the proof of stake, the proof of capacity, the proof of burn, or the proof of elapsed time, adding the transaction to the first blockchain.

B. A system comprising: one or more processors; and computer readable media storing instructions that, when executed by the one or more processors, cause the system to perform operations comprising: receiving, from a first delegate instantiated on a first blockchain, a first message to initiate on a second blockchain a transaction associated with a user, wherein the first message comprises a unique delegate network address associated with the user and the first blockchain; causing, based at least in part on receiving the first message, the transaction to occur on the second blockchain; determining, based at least in part on causing the transaction to occur, an asset balance of an asset associated with the second blockchain; and transmitting a second message verifying completion of the transaction, wherein the second message comprises at least an association between the unique delegate network address and the asset balance of the asset associated with the second blockchain.

C. A method for transacting in a delegate interoperability network, wherein the delegate interoperability network comprises a plurality of delegates instantiated on a plurality of different blockchains, the method comprising: receiving, from a first delegate instantiated on a first blockchain, a first message to initiate on a second blockchain a transaction associated with a user, wherein the first message comprises a unique delegate network address associated with the user; causing, based at least in part on receiving the first message, the transaction to occur on the second blockchain; determining, based at least in part on causing the transaction to occur, an asset balance of an asset associated with the second blockchain; and sending a second message verifying completion of the transaction, wherein the second message comprises at least an association between the unique delegate network address and the asset balance of the asset associated with the second blockchain.

D: A method for exchanging data in a delegate interoperability network, wherein the delegate interoperability network comprises a plurality of delegates instantiated on a plurality of different blockchains, the method comprising the steps of: receiving, by a first delegate instantiated on a first blockchain, a request to initiate, on a second blockchain, a data exchange on behalf of a user; generating, by the first delegate, a unique delegate network address associated with the user and the first blockchain; determining, by the first delegate, whether the second blockchain has sufficient gas token liquidity to complete the data exchange; based at least in part on determining that the second blockchain has sufficient gas token liquidity, transmitting, by the first delegate to a second delegate instantiated on the second blockchain, a first message to initiate the data exchange, wherein the first message comprises the unique delegate network address; and receiving, from the second delegate, a second message, wherein the second message comprises at least an association between the unique delegate network address and the second blockchain.

E: The method of paragraph D, further comprising the steps of: generating at least one cryptographic consensus associated with the data exchange; and based at least in part on verifying the at least one cryptographic consensus, adding the data exchange to the first blockchain.

F: The method of either paragraph D or E, wherein the plurality of different blockchains comprises a parent blockchain, and wherein the first blockchain comprises a first fork of the parent blockchain and the second blockchain comprises a second fork of the parent blockchain.

G: The method of any one of paragraphs D-F, wherein the first delegate is configured to send and receive data from other delegates instantiated on the first blockchain.

H: The method of any one of paragraphs D-G, wherein the first delegate is deployed on a Web D.0 service or a Web E.0 service, and wherein the first delegate is configured to authenticate the user via one or more Web D.0 or Web E.0 authentication services.

I: The method of any one of paragraphs D-H, wherein the request identifies a first blockchain asset associated with the first blockchain, and further wherein the request comprises a cryptographic key associated with the user that verifies the user's ownership of the first blockchain asset.

J: The method of paragraph I, wherein the first blockchain asset is one of a cryptocurrency, a non-fungible token (NFT), a gas token, a message, or a decentralized application.

K: The method of any one of paragraphs D-J, further comprising the step of: generating an asset associated with the second blockchain.

L: The method of paragraph K, further comprising the step of: identifying a payee address associated with the asset and the second blockchain.

M: The method of any one of paragraphs D-L, further comprising the steps of: determining a failure to transmit the first message to initiate the data exchange; re-transmitting the first message to initiate the data exchange; and wherein the second message further comprises a verification of completion of the data exchange.

N: One or more non-transitory computer readable media storing computer-executable instructions that, when executed by one or more processors of a computing device, cause the computing device to perform operations comprising: receiving, by a first delegate instantiated on a first blockchain, a request to initiate, on a second blockchain, a data exchange on behalf of a user; generating, by the first delegate, a unique delegate network address associated with the user and the first blockchain; determining, by the first delegate, whether the second blockchain has sufficient gas token liquidity to complete the data exchange; based at least in part on determining that the second blockchain has sufficient gas token liquidity, transmitting, to a second delegate instantiated on the second blockchain, a first message to initiate the data exchange, wherein the first message comprises the unique delegate network address; and receiving, from the second delegate, a second message, wherein the second message comprises at least an association between the unique delegate network address and the second blockchain.

O: The one or more non-transitory computer readable media of paragraph N, the operations further comprising: generating at least one cryptographic consensus associated with the data exchange; and based at least in part on verifying the at least one cryptographic consensus, adding the data exchange to the first blockchain.

P: The one or more non-transitory computer readable media of either paragraph N or O, wherein the plurality of different blockchains comprises a parent blockchain, and wherein the first blockchain comprises a first fork of the parent blockchain and the second blockchain comprises a second fork of the parent blockchain.

Q: The one or more non-transitory computer readable media of any one of paragraphs N-P, wherein the first delegate is configured to send and receive data from other delegates instantiated on the first blockchain.

R: The one or more non-transitory computer readable media of any one of paragraphs N-Q, wherein the first delegate is deployed on a Web D.0 service or a Web E.0 service, and wherein the first delegate is configured to authenticate the user using one or more Web D.0 or Web E.0 authentication services.

S: The one or more non-transitory computer readable media of any one of paragraphs N-R, wherein the request identifies a first blockchain asset associated with the first blockchain, and further wherein the request comprises a cryptographic key associated with the user that verifies the user's ownership of the first blockchain asset.

T: The one or more non-transitory computer readable media of paragraph S, wherein the first blockchain asset is one of a cryptocurrency, a non-fungible token (NFT), a gas token, a message, or a decentralized application.

U: The one or more non-transitory computer readable media of any one of paragraphs N-T, further comprising: determining a failure to transmit the first message to initiate the data exchange; re-transmitting the first message to initiate the data exchange; and wherein the second message further comprises a verification of completion of the data exchange.

V: A system comprising: one or more processors; and computer readable media storing instructions that, when executed by the one or more processors, cause the system to perform operations comprising: receiving, by a first delegate instantiated on a first blockchain, a request to initiate, on a second blockchain, a data exchange on behalf of a user; generating, by the first delegate, a unique delegate network address associated with the user and the first blockchain; determining, by the first delegate, whether the second blockchain has sufficient gas token liquidity to complete the data exchange; based at least in part on determining that the second blockchain has sufficient gas token liquidity, transmitting, by the first delegate to a second delegate instantiated on the second blockchain, a first message to initiate the data exchange, wherein the first message comprises the unique delegate network address; and receiving, from the second delegate, a second message, wherein the second message comprises at least an association between the unique delegate network address and the second blockchain.

W: The system of paragraph V, the operations further comprising: determining a failure to transmit the first message to initiate the data exchange; re-transmitting the first message to initiate the data exchange; and wherein the second message further comprises a verification of completion of the data exchange.

What is claimed is:

1. A method for exchanging data in a delegate interoperability network, wherein the delegate interoperability network comprises a plurality of delegates instantiated on a plurality of different blockchains, the method comprising the steps of:
receiving, by a first delegate instantiated on a first blockchain, a request to initiate, on a second blockchain, a data exchange on behalf of a user;
generating, by the first delegate, a unique delegate network address associated with the user and the first blockchain;
determining, by the first delegate, whether the second blockchain has sufficient gas token liquidity to complete the data exchange;
based at least in part on determining that the second blockchain has sufficient gas token liquidity, transmitting, by the first delegate to a second delegate instantiated on the second blockchain, a first message to initiate the data exchange, wherein the first message comprises the unique delegate network address; and
receiving, from the second delegate, a second message, wherein the second message comprises at least an association between the unique delegate network address and the second blockchain.

2. The method of claim 1, further comprising the steps of:
generating at least one cryptographic consensus associated with the data exchange; and
based at least in part on verifying the at least one cryptographic consensus, adding the data exchange to the first blockchain.

3. The method of claim 1, wherein the plurality of different blockchains comprises a parent blockchain, and wherein the first blockchain comprises a first fork of the parent blockchain and the second blockchain comprises a second fork of the parent blockchain.

4. The method of claim 1, wherein the first delegate is configured to send and receive data from other delegates instantiated on the first blockchain.

5. The method of claim 1, wherein the first delegate is deployed on a Web 1.0 service or a Web 2.0 service, and wherein the first delegate is configured to authenticate the user via one or more Web 1.0 or Web 2.0 authentication services.

6. The method of claim 1, wherein the request identifies a first blockchain asset associated with the first blockchain, and further wherein the request comprises a cryptographic key associated with the user that verifies the user's ownership of the first blockchain asset.

7. The method of claim 6, wherein the first blockchain asset is one of a cryptocurrency, a non-fungible token (NFT), a gas token, a message, or a decentralized application.

8. The method of claim 1, further comprising the step of: generating an asset associated with the second blockchain.

9. The method of claim 8, further comprising the step of: identifying a payee address associated with the asset and the second blockchain.

10. The method of claim 1, further comprising the steps of:
determining a failure to transmit the first message to initiate the data exchange;
re-transmitting the first message to initiate the data exchange; and
wherein the second message further comprises a verification of completion of the data exchange.

11. One or more non-transitory computer readable media storing computer-executable instructions that, when executed by one or more processors of a computing device, cause the computing device to perform operations comprising:
receiving, by a first delegate instantiated on a first blockchain, a request to initiate, on a second blockchain, a data exchange on behalf of a user;
generating, by the first delegate, a unique delegate network address associated with the user and the first blockchain;
determining, by the first delegate, whether the second blockchain has sufficient gas token liquidity to complete the data exchange;
based at least in part on determining that the second blockchain has sufficient gas token liquidity, transmitting, to a second delegate instantiated on the second blockchain, a first message to initiate the data exchange, wherein the first message comprises the unique delegate network address; and
receiving, from the second delegate, a second message, wherein the second message comprises at least an association between the unique delegate network address and the second blockchain.

12. The one or more non-transitory computer readable media of claim 11, the operations further comprising:
generating at least one cryptographic consensus associated with the data exchange; and
based at least in part on verifying the at least one cryptographic consensus, adding the data exchange to the first blockchain.

13. The one or more non-transitory computer readable media of claim 11, wherein the plurality of different blockchains comprises a parent blockchain, and wherein the first blockchain comprises a first fork of the parent blockchain and the second blockchain comprises a second fork of the parent blockchain.

14. The one or more non-transitory computer readable media of claim 11, wherein the first delegate is configured to send and receive data from other delegates instantiated on the first blockchain.

15. The one or more non-transitory computer readable media of claim 11, wherein the first delegate is deployed on a Web 1.0 service or a Web 2.0 service, and wherein the first delegate is configured to authenticate the user using one or more Web 1.0 or Web 2.0 authentication services.

16. The one or more non-transitory computer readable media of claim 11, wherein the request identifies a first blockchain asset associated with the first blockchain, and further wherein the request comprises a cryptographic key associated with the user that verifies the user's ownership of the first blockchain asset.

17. The one or more non-transitory computer readable media of claim 16, wherein the first blockchain asset is one of a cryptocurrency, a non-fungible token (NFT), a gas token, a message, or a decentralized application.

18. The one or more non-transitory computer readable media of claim 11, further comprising:
determining a failure to transmit the first message to initiate the data exchange;
re-transmitting the first message to initiate the data exchange; and
wherein the second message further comprises a verification of completion of the data exchange.

19. A system comprising:
one or more processors; and
computer readable media storing instructions that, when executed by the one or more processors, cause the system to perform operations comprising:
receiving, by a first delegate instantiated on a first blockchain, a request to initiate, on a second blockchain, a data exchange on behalf of a user;
generating, by the first delegate, a unique delegate network address associated with the user and the first blockchain;
determining, by the first delegate, whether the second blockchain has sufficient gas token liquidity to complete the data exchange;
based at least in part on determining that the second blockchain has sufficient gas token liquidity, transmitting, by the first delegate to a second delegate instantiated on the second blockchain, a first message to initiate the data exchange, wherein the first message comprises the unique delegate network address; and
receiving, from the second delegate, a second message, wherein the second message comprises at least an association between the unique delegate network address and the second blockchain.

20. The system of claim 19, the operations further comprising:
determining a failure to transmit the first message to initiate the data exchange;
re-transmitting the first message to initiate the data exchange; and
wherein the second message further comprises a verification of completion of the data exchange.
